(19) United States
(12) Patent Application Publication
(10) Pub. No.: US 2026/0194251 A1
(43) Pub. Date: Jul. 9, 2026

(54) SAFETY CABINET AND EQUIPMENT MONITORING SYSTEM

(71) Applicant: Hitachi Industrial Equipment Systems Co., Ltd., Tokyo (JP)

(72) Inventor: Takeshi KANEKO, Tokyo (JP)

(21) Appl. No.: 19/128,204

(22) PCT Filed: Mar. 9, 2023
(86) PCT No.: PCT/JP2023/008976

§ 371 Date: May 8, 2025

(51) Int. Cl. F24F 11/526; B01L 1/00; F24F 3/163

(52) U.S. Cl. CPC F24F 11/526; B01L 1/50; F24F 3/163; B01L 2200/082; B01L 2200/143

(57) ABSTRACT

A safety cabinet includes: an opening portion for exhausting air in a work space; an exhaust duct connected to the opening portion; a remote blower that sends the air in the work space to outdoors from the exhaust duct; and a safety cabinet control unit that transmits a signal to an arithmetic processing device, which notifies the worker based on the values indicating the operating state of the remote blower.

### TECHNICAL FIELD

The present invention relates to a safety cabinet and an equipment monitoring system used in industrial fields such as pharmaceuticals, medical treatment, and regenerative medicine.

### BACKGROUND ART

In the development of pharmaceuticals, research on pathogens such as viruses, or the like, a safety cabinet is used for protecting workers, protecting samples, and the like. In the safety cabinet, air in a work space in which contaminants are handled is filtered by a high efficiency particulate air filter (HEPA filter) so as to prevent the contaminants from being discharged to the outside of the device, and the air from which the contaminants are removed is exhausted to the outside of the device.

In a case where a large amount of gaseous or volatile hazardous substances are handled in such a safety cabinet, when the hazardous substances are exhausted to a laboratory, the concentration of the hazardous substances exceeds work environment standards. In addition, when substances that cannot be collected by the HEPA filter or highly active substances such as an anti-cancer agent are handled, it is risky to exhaust the substances to the laboratory.

For that reason, in addition to a blower of the safety cabinet, a remote blower is installed in a building, and direct duct connection is used to connect the safety cabinet to the remote blower while sealing a space between the safety cabinet and a duct, so that the exhaust from the safety cabinet is allowed to be discharged to the outdoors, and the work environment is managed. Incidentally, regulations related to this include the Industrial Safety and Health Act, the Offensive Odor Prevention Act, the Air Pollution Control Act, and the like.

There is Patent Document 1 that discloses the technique of direct duct connection that connects the safety cabinet to the remote blower while sealing the space between the safety cabinet and the duct. Patent Document 1 describes that in a method for inspecting the exhaust duct connection of a safety cabinet, a connection method for an exhaust duct is determined based on an output of pressure detection means or air volume detection means and an operating state of air blowing means, and an alarm unit issues a warning when the connection method for the exhaust duct is inappropriate.

### CITATION LIST

### Patent Document

Patent Document 1: JP 2019-74237 A

### SUMMARY OF THE INVENTION

### Problems to be Solved by the Invention

Patent Document 1 describes that a warning is issued when the connection method for the exhaust duct is inappropriate; however, if a failure occurs in the remote blower of the building, causing an abnormality in the exhaust duct system, the exhaust airflow of the safety cabinet decreases, making it impossible to maintain the air barrier at the work opening of the safety cabinet. As a result, contaminants may escape from the work opening, posing a risk of exposure to the operator.

Additionally, there is a risk that workers in the building may be exposed to contaminants when entering a laboratory where the safety cabinet is installed.

An object of the present invention is to provide a technique that can notify workers of the degree of a risk in the work environment.

### Solutions to Problems

In order to solve the above-described problems, one of representative safety cabinets of the present invention includes: a safety cabinet with an opening portion for exhausting air in a work space; an exhaust duct connected to the opening portion; a remote blower that sends the air in the work space to outdoors from the exhaust duct; and a control unit that transmits a signal to a notification system, which notifies the worker, based on the values indicating the operating state of the remote blower.

### Effects of the Invention

According to the present invention, it is possible to notify a worker of the degree of a risk in the work environment. Issues, configurations, and effects other than those described above will be apparent from the description of the following embodiments.

### BRIEF DESCRIPTION OF THE DRAWINGS

FIG. 1 is a right side view showing one example of a schematic configuration of a safety cabinet.

FIG. 2 is a right side view showing another example of the schematic configuration of the safety cabinet.

FIG. 3 is a front view showing one example of a configuration of a safety cabinet of a first embodiment.

FIG. 4 is a right side view showing one example of the configuration of the safety cabinet of the first embodiment.

FIG. 5 is a flowchart showing one example of the operation of the safety cabinet of the first embodiment.

FIG. 6 is a front view showing one example of configuration of a safety cabinet of a second embodiment.

FIG. 7 is a flowchart showing one example of the operation of the safety cabinet of the second embodiment.

FIG. 8 is a flowchart showing one example of the operation of a safety cabinet of a third embodiment.

FIG. 9 is a view showing one example of a screen displayed on a display unit of the safety cabinet of the third embodiment.

FIG. 10 is a right side view showing one example of a configuration of a safety cabinet of a fourth embodiment.

FIG. 11 is a flowchart showing one example of the operation of the safety cabinet of the fourth embodiment.

FIG. 12 is a right side view showing one example of a configuration of a safety cabinet of a fifth embodiment.

FIG. 13 is a right side view showing one example of a configuration of a safety cabinet of a sixth embodiment.

### MODE FOR CARRYING OUT THE INVENTION

Hereinafter, embodiments will be described with reference to the drawings.

However, the present invention should not be interpreted as being limited to the contents of the embodiments described below. Those skilled in the art would easily understand that specific configurations of the present invention can be changed without departing from the concept or scope of the present invention.

Incidentally, in each drawing for describing the embodiments, the same components are denoted by the same names and reference signs, and the repeated descriptions thereof will be omitted.

First, a safety cabinet provided with two HEPA filters for exhaust to detoxify contaminated air will be described. In the safety cabinet, when a highly toxic substance is handled, detoxified air is exhausted by passing contaminated air through a HEPA filter for exhaust twice. TWO HEPA filters for exhaust are provided, and approximately 99% of contaminants can be removed by passing air through a first HEPA filter for exhaust, and almost 100% of the contaminants can be removed by passing the air through a second HEPA filter for exhaust.

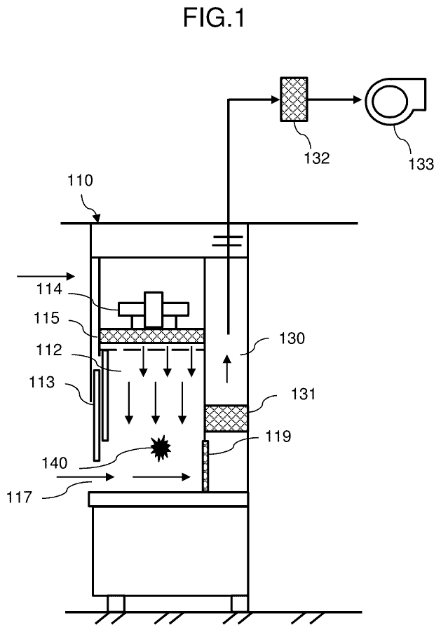

FIG. 1 is a right side view showing one example of a schematic configuration of the safety cabinet.

As shown in FIG. 1, a safety cabinet 110 includes a work space 112 inside, the front surface of the safety cabinet 110 being configured with a front shutter 113. An air supply fan 114 and a HEPA filter 115 for air supply are provided above the work space 112. The air supply fan 114 supplies clean air, which has passed through the HEPA filter 115 for air supply, to the work space 112. A back flow path 130 is provided at the back of the work space 112, and a pre-filter 119 is provided between the work space 112 and the back flow path 130.

A first HEPA filter 131 for exhaust for exhaust is provided in the back flow path 130, and a second HEPA filter 132 for exhaust for exhaust is further provided in a building exhaust duct system or a machine room therebeyond. A remote blower 133 is provided above the safety cabinet 110.

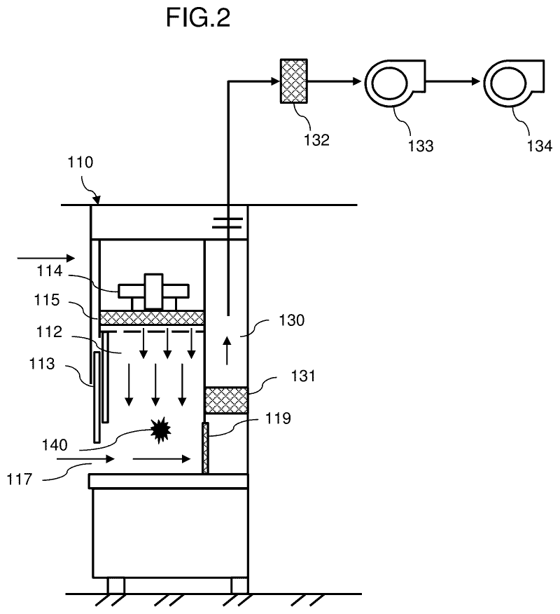

Air supplied to the work space 112 from above and air taken into the work space 112 from a work opening portion 117 pass through the pre-filter 119 to flow through the back flow path 130, a contaminant 140 is removed from the air by the first HEPA filter 131 for exhaust and the second HEPA filter 132 for exhaust, and the air is exhausted to the outdoors by the remote blower 133. Incidentally, as shown in FIG. 2, two or more remote blowers may be provided.

FIG. 2 is a right side view showing another example of the schematic configuration of the safety cabinet.

The safety cabinet 110 of FIG. 2 differs from that of FIG. 1 in that two remote blowers, namely, the remote blower 133 and a backup remote blower 134 are provided. The safety cabinet 110 can ensure a certain volume of exhaust if the other remote blower continues to operate in the case of a failure of one remote blower. However, when one remote blower stops, the exhaust air volume decreases, so that there is a possibility that the air barrier of the work opening portion 117 decreases and the contaminant 140 handled in the work space 112 leaks. For that reason, when one remote blower fails, the safety of a worker is not ensured, and work needs to be suspended.

### First Embodiment

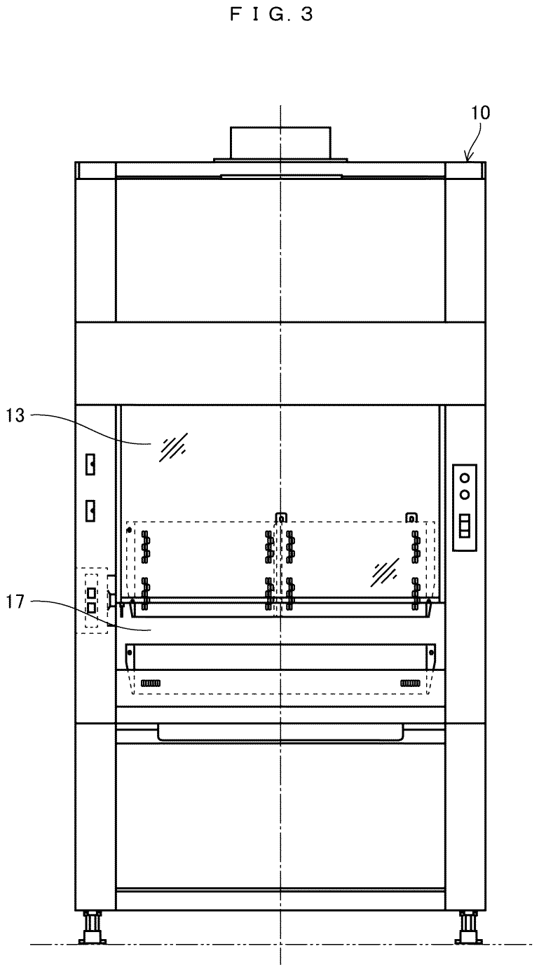

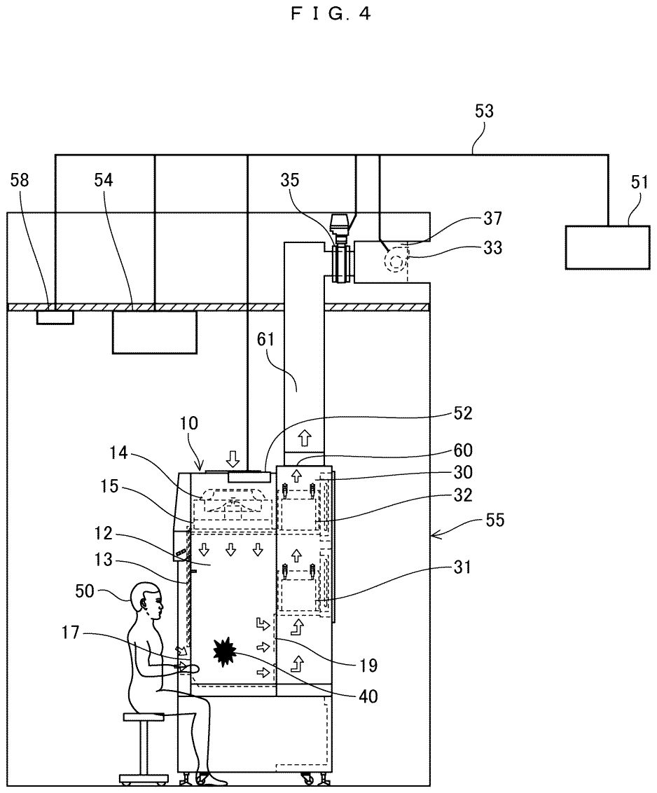

FIGS. 3 and 4 are views showing one example of a configuration of a safety cabinet of a first embodiment, FIG. 3 is a front view, and FIG. 4 is a right side view. Incidentally, in the present embodiment, the safety cabinet provided with two HEPA filters for exhaust will be described as an example; however, the present invention is not limited thereto.

As shown in FIG. 3, a safety cabinet 10 includes a front shutter 13, which opens and closes up and down, on the front surface, and includes a work opening portion 17 for performing work below the front shutter 13.

As shown in FIG. 4, the safety cabinet 10 is installed in a laboratory 55 in a building, includes a work space 12 inside, and includes an air supply fan 14 and a HEPA filter 15 for air supply above the work space 12. The air supply fan 14 takes in air from the outside of the safety cabinet 10, and supplies clean air, which has passed through the HEPA filter 15 for air supply, to the work space 12. A worker 50 inserts the hands from the work opening portion 17 below the front shutter 13, and performs work in the work space 12.

The safety cabinet 10 includes a back flow path 30 at the back of the work space 12, and includes a pre-filter 19 between the work space 12 and the back flow path 30. Two HEPA filters 31 and 32 for exhaust are provided in the back flow path 30.

An opening portion 60 for exhausting the air, which has passed through the two HEPA filters for exhaust in the back flow path 30, to the outside of the safety cabinet 10 is provided at an upper portion of the safety cabinet 10, and the opening portion 60 is connected to a vertical flow path 61. The vertical flow path 61 is connected to an exhaust duct 37 via an electric valve 35. The electric valve 35 adjusts the air volume passing through the exhaust duct 37. The exhaust duct 37 includes a remote blower 33 that sends the air from the exhaust duct 37 to the outdoors.

Air supplied to the work space 12 from above and air taken into the work space 12 from the work opening portion 17 pass through the pre-filter 19 to flow through the back flow path 30, a contaminant 40 is removed from the air by a first HEPA filter 31 for exhaust and a second HEPA filter 32 for exhaust, and the air is exhausted from the exhaust duct 37 to the outdoors.

In addition, the safety cabinet 10 includes a safety cabinet control unit 52 that performs operation control of the air supply fan 14 and the like. The laboratory 55 is provided with a display unit 54 and a buzzer 58. The display unit 54 is composed of a liquid crystal monitor or the like, and displays an operating state of the air supply fan 14 or the remote blower 33 or the like.

An arithmetic processing device 51 is installed in a management room of the building. The arithmetic processing device 51 constitutes a notification system that notifies workers in the building of a risk such as exposure to the contaminant by performing control, broadcasting, or the like on the display units 54 and the buzzers 58 in other laboratories throughout the building in addition to the laboratory 55 shown in FIG. 4.

The safety cabinet control unit 52, the display unit 54, the buzzer 58, the electric valve 35, the remote blower 33, and the arithmetic processing device 51 are connected to each other via a control line 53.

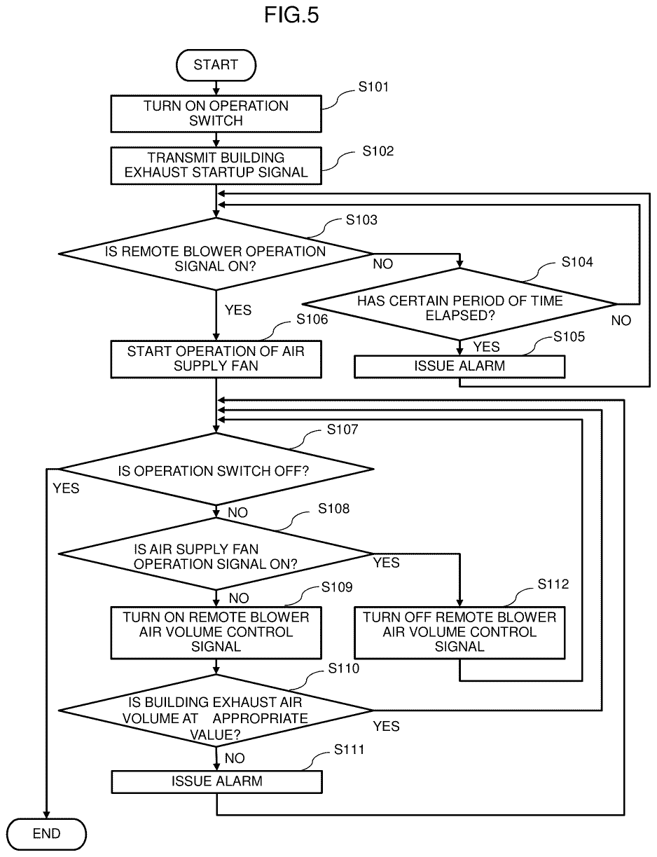

FIG. 5 is a flowchart showing one example of the operation of the safety cabinet of the first embodiment.

As shown in FIG. 5, when an operation switch of the safety cabinet 10 is turned ON (step S101), a building exhaust startup signal is transmitted from the safety cabinet control unit 52 to the remote blower 33 via the control line 53 (step S102). When the remote blower 33 receives the building exhaust startup signal and starts operating, the remote blower 33 transmits a remote blower operation signal to the safety cabinet control unit 52.

The safety cabinet control unit 52 determines whether or not the remote blower operation signal is turned ON (step S103). When the remote blower operation signal is not turned ON (NO in step S103), the process waits for the remote blower operation signal to turn ON, and when a certain period of time has elapsed without the remote blower operation signal being turned ON, (YES in step S104), the buzzer 58 issues an alarm (step S105), and the process returns to step S103.

When the remote blower operation signal is turned ON (YES in step S103), the safety cabinet control unit 52 starts the operation of the air supply fan 14 after a certain period of time has elapsed (step S106), the safety cabinet 10 enters a normal operating state, and the worker 50 can be performed an experiment. The electric valve 35 is constantly ON, and maintains a state where a damper is opened.

In order to prevent the leakage of the contaminant 40 to the outside of the machine due to the work space 12 becoming positive pressure, an interlock is applied such that the air supply fan 14 starts operating after the remote blower 33 starts operating.

Next, the safety cabinet control unit 52 determines whether or not the operation switch of the safety cabinet 10 is turned OFF (step S107), and when the operation switch of the safety cabinet 10 is turned OFF, the safety cabinet control unit 52 stops the safety cabinet 10 and ends the process by stopping the operation of the air supply fan 14 and stopping the operation of the remote blower 33 after a certain period of time has elapsed.

In order to prevent the leakage of the contaminant 40 to the outside of the machine due to the work space 12 becoming positive pressure, an interlock is applied such that the remote blower 33 stops operating after the air supply fan 14 stops operating.

On the other hand, when the operation switch of the safety cabinet 10 is not turned OFF (NO in step S107), the process proceeds to step S108.

In step S108, the safety cabinet control unit 52 determines whether or not an air supply fan operation signal is ON, to monitor an abnormal stop of the air supply fan 14. In a case where the air supply fan 14 has abnormally stopped, when the remote blower 33 continues to operate while maintaining a constant exhaust air volume, the air volume flowing in from the work opening portion 17 becomes excessive. For that reason, there is a risk that the contaminant 40 flies up in the work space 12 to contaminate the work space 12 and the contaminant 40 leaks from the safety cabinet 10.

When the air supply fan 14 stops abnormally and the air supply fan operation signal is OFF (NO in step S108), in order to prevent the leakage of the contaminant 40, a remote blower air volume control signal is turned ON (step S109). The remote blower 33 receives an indication of the remote blower air volume control signal being turned ON, and is controlled to suppress the air volume. An increase in the air volume flowing in from the work opening portion 17 can be prevented by suppressing the air volume of the remote blower 33 equivalent to an air volume when the air supply fan 14 is in operation.

At this time, the pressure in the exhaust duct 37 is monitored, and it is determined whether or not the building exhaust air volume is at an appropriate value (step S110). A sensor (not shown) detects a pressure in the exhaust duct 37. The safety cabinet control unit 52 calculates a building exhaust air volume based on the pressure detected by the sensor, and determines whether or not the building exhaust air volume is at the appropriate value. When the building exhaust air volume is at a higher value than the appropriate value, the air volume flowing in from the work opening portion 17 becomes excessive, so that there is a risk that the contaminant 40 flies up in the work space 12 to contaminate the work space 12 and the contaminant 40 leaks from the safety cabinet 10. When the building exhaust air volume is at a lower value than the appropriate value, there is a risk that the air barrier of the work opening portion 17 decreases and the contaminant 40 leaks from the work opening portion 17.

When the building exhaust air volume is at the appropriate value, the process returns to step S107, and the operation of the remote blower 33 is continued. On the other hand, when the building exhaust air volume is not at the appropriate value in step (NO in step S110), the buzzer 58 issues an alarm to attract attention (step S111), the process returns to step S107, and the operation of the remote blower 33 is continued.

In step S108, when the air supply fan operation signal is ON, the safety cabinet control unit 52 turns OFF the remote blower air volume control signal (step S112), the process returns to step S107, and continues the operation of the remote blower 33.

According to the present embodiment, when the air supply fan 14 has abnormally stopped, the worker can be prevented from being exposed to the contaminant by suppressing the air volume of the remote blower 33 through turning ON the remote blower air volume control signal.

### Second Embodiment

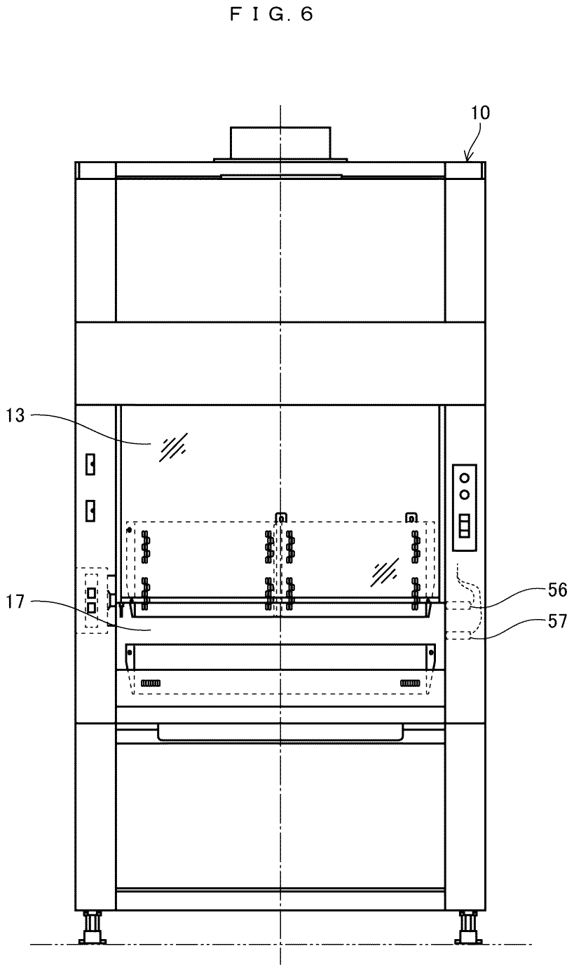

FIG. 6 is a front view showing one example of a configuration of a safety cabinet of a second embodiment.

Similarly to the first embodiment, in the second embodiment, the operating state of the remote blower 33 is changed by a command from the safety cabinet.

When the worker 50 performs an experiment using the safety cabinet 10, in order to ensure the air barrier of the work opening portion 17, it is necessary to use the safety cabinet 10 at a predetermined opening height determined for the safety cabinet 10. For that reason, an opening limit switch 56 is provided to monitor whether or not the front shutter 13 is set at a correct position.

On the other hand, even when the safety cabinet 10 is not in use, the remote blower 33 continues to operate such that the contaminant 40 in the work space 12 does not leak. At this time, a power saving limit switch 57 is provided at a position where the opening height of the front shutter 13 is lower than when the safety cabinet is in use. When the safety cabinet control unit 52 receives a position information signal of the power saving limit switch 57, the safety cabinet control unit 52 suppresses the air volume of the remote blower 33. Accordingly, the power consumption when the safety cabinet 10 is not in use can be reduced.

In a case where the opening height of the front shutter 13 is lowered, when the remote blower 33 continues to operate while maintaining a constant exhaust air volume, the air volume flowing in from the work opening portion 17 becomes excessive. For that reason, there is a risk that the contaminant 40 flies up in the work space 12 to contaminate the work space 12 and the contaminant 40 leaks from the safety cabinet 10. By suppressing the air volume of the remote blower 33, the exhaust air volume of the safety cabinet 10 can be maintained at an appropriate value, and the worker 50 can be prevented from being exposed to the contaminant.

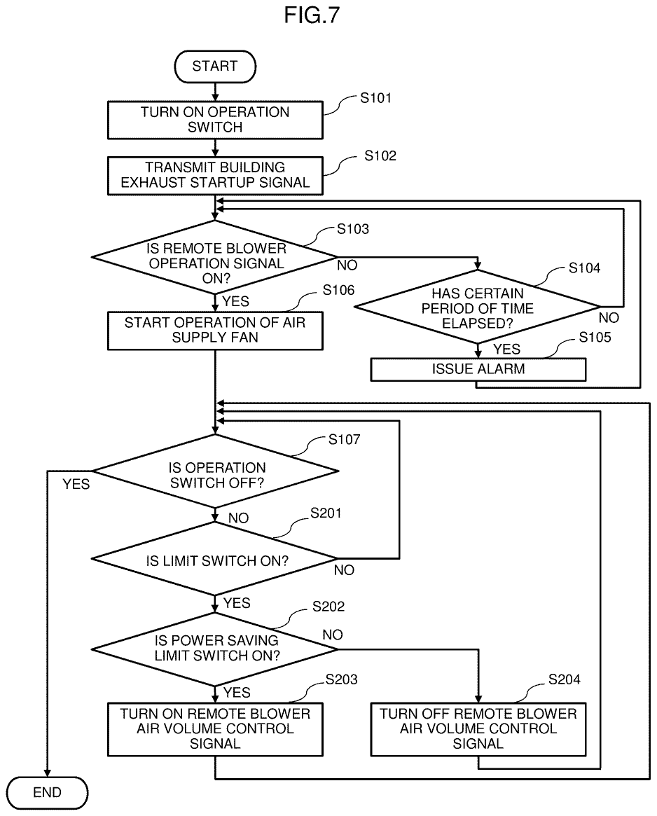

FIG. 7 is a flowchart showing one example of the operation of the safety cabinet of the second embodiment.

In FIG. 7, the same steps in FIG. 5 are denoted by the same reference signs, and the descriptions thereof will be omitted.

The safety cabinet control unit 52 determines whether or not the position information signal of the opening limit switch 56 or the power saving limit switch 57 is turned ON and the front shutter 13 is set at the correct position (step S201). When any of the position information signals of the opening limit switch 56 and the power saving limit switch 57 is not turned ON (NO in step S201), the process returns to step S107.

When the position information signal of the opening limit switch 56 or the power saving limit switch 57 is turned ON (YES in step S201), it is determined whether or not the position information signal of the power saving limit switch 57 is turned ON (step S202).

When the position information signal of the power saving limit switch 57 is ON (YES in step S202), the remote blower air volume control signal is turned ON (step S203), and the process returns to step S107. The remote blower 33 receives an indication of the remote blower air volume control signal being turned ON, and is controlled to suppress the air volume.

In step S108, when the position information signal of the power saving limit switch 57 is not ON, the remote blower air volume control signal is turned OFF (step S204), and the process returns to step S107.

According to the present embodiment, when the safety cabinet is not in use, by lowering the opening height of the front shutter 13 and by suppressing the air volume of the remote blower 33, the power consumption can be reduced, and the worker can be prevented from being exposed to the contaminant.

### Third Embodiment

In the present embodiment, an example in which fluctuations in the air barrier of the work opening portion 17 caused by fluctuations in the exhaust air volume of the safety cabinet 10 or the power supply of the safety cabinet 10 is monitored will be described.

Fluctuations in the exhaust air volume may be a sign of a failure of the remote blower 33. In addition, an abnormality in the power supply of the safety cabinet 10 causes the remote blower 33 to stop. By monitoring the fluctuations or the power supply, the safety of the work environment of the safety cabinet 10 can be confirmed, and when an abnormality has occurred, the notification system of the building can notify workers of the degree of a risk in the work environment. The notification system is composed of the arithmetic processing device 51 and the like.

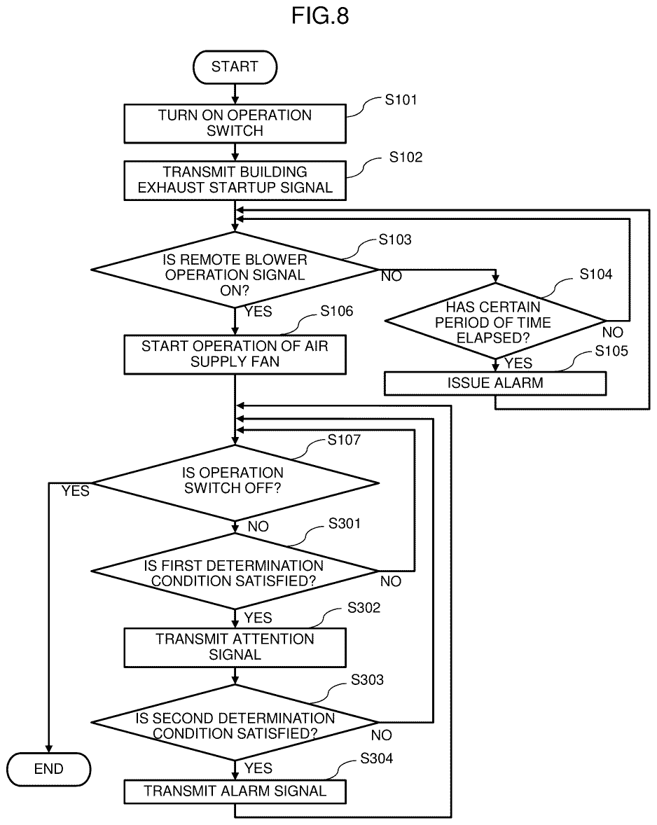

FIG. 8 is a flowchart showing one example of the operation of the safety cabinet of a third embodiment.

In FIG. 8, the same steps in FIG. 5 are denoted by the same reference signs, and the descriptions thereof will be omitted.

After the air supply fan 14 of the safety cabinet 10 starts operating, the safety cabinet control unit 52 determines whether or not values indicating the operating state of the remote blower 33 satisfy first determination conditions determined in advance (step S301), to constantly monitor the operating state of the safety cabinet 10.

Here, the values indicating the operating state of the remote blower 33 include a plurality of items such as exhaust air volume, voltage fluctuation, instantaneous power outage, and the state of an uninterruptible power supply (UPS) that supplies power to the safety cabinet 10 during a power outage. Incidentally, the operating state of the remote blower 33 may be monitored by monitoring the HEPA filters 31 and 32 for exhaust for the pressure in the exhaust duct 37 instead of the exhaust air volume.

The first determination conditions are determined for the plurality of respective items in advance, and when a value indicating the operating state satisfies the first determination condition, it is determined that a slight abnormality has occurred in the operating state of the remote blower 33. One example of the first determination conditions is that the exhaust air volume is less than or equal to a lower limit value of the exhaust air volume of the safety cabinet 10.

When the operating state of the remote blower 33, for example, a value indicating the exhaust air volume satisfies the first determination condition (YES in step S301), an attention signal is transmitted from the safety cabinet control unit 52 to the arithmetic processing device 51 installed in the management room of the building (step S302).

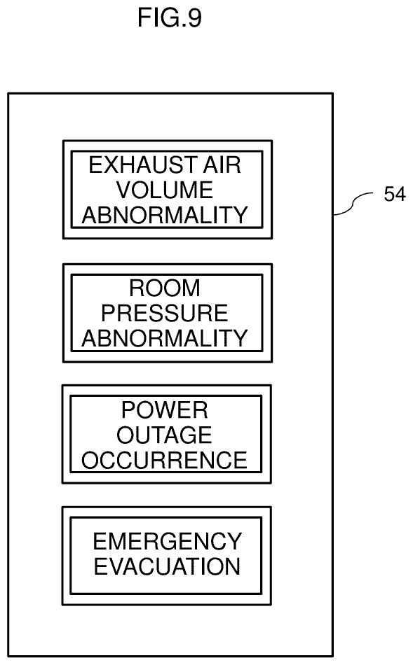

The arithmetic processing device 51 that has received the attention signal attracts attention of the worker 50 by controlling the display unit 54, which is installed in the safety cabinet 10, to display a screen as shown in FIG. 9, for example, to display indication such as “exhaust air volume abnormality” or “room pressure abnormality” in yellow.

In addition, the arithmetic processing device 51 attracts attention of the worker 50 by controlling the buzzer 58, which is installed in the safety cabinet 10, to make sound.

Next, it is determined whether or not the values indicating the operating state of the safety cabinet 10 satisfy second determination conditions determined in advance (step S303).

The second determination conditions are determined for the plurality of respective items regarding the operating state of the safety cabinet 10 in advance, and when a value indicating the operating state satisfies the second determination condition, it is determined that a serious abnormality has occurred in the operating state of the remote blower 33. In this case, the worker 50 needs to evacuate from the laboratory 55. In addition, it is risky for workers in the building to enter the laboratory 55.

When the values indicating the operating state of the safety cabinet 10 satisfy the second determination conditions determined in advance (YES in step 303), the safety cabinet control unit 52 switches the attention signal to an alarm signal, and transmits the alarm signal to the arithmetic processing device 51 (step S304).

Incidentally, when the values indicating the operating state for a number of the plurality of items determined in advance, for example, more two or items satisfy the first determination conditions, the attention signal may be switched to the alarm signal. For example, when the exhaust air volume and the voltage fluctuation satisfy the first determination conditions, the attention signal may be switched to the alarms signal.

In addition, when a state where the values indicating the operating state satisfy the first determination conditions continues for a time determined in advance, the attention signal may be switched to the alarm signal. For example, when a state where the exhaust air volume satisfies the first determination condition continues for the time determined in advance, the attention signal may be switched to the alarm signal.

The arithmetic processing device 51 that has received the alarm signal prompts workers in the building to evacuate by controlling the display unit 54, which is installed in each laboratory of the building, to display the screen as shown in FIG. 9, for example, to display an indication such as “power outage occurrence” or “emergency evacuation” in red.

In addition, the arithmetic processing device 11 prompts workers in the building to evacuate by controlling the buzzer 58, which is installed in each laboratory of the building, to make sound at a sound tone or intervals changed compared to when the attention signal is received.

Further, the arithmetic processing device 11 issues an alarm by broadcasting throughout the building so as to avoid entering the laboratory 55.

An alarm can be issued throughout the building through conjunction with the arithmetic processing device 51 of the building, and when a serious abnormality occurs in the operating state of the remote blower 33, it is possible to restrict entry to the installation location of the safety cabinet 10, or to prompt workers to evacuate from the installation location of the safety cabinet 10.

Incidentally, the display unit 54 and the buzzer 58 are installed in each laboratory of the building, but may be installed at other locations such as the management room or a hallway.

According to the present embodiment, since the attention signal or the alarm signal is transmitted to the arithmetic processing device 51 of the building based on the values indicating the operating state of the remote blower 33, the worker can be notified of the degree of risk in the work environment.

In addition, the arithmetic processing device 51 notifies the worker 50 of the safety cabinet 10 when a slight abnormality occurs in the operating state of the remote blower 33, and notifies workers throughout the building when a serious abnormality occurs in the operating state of the remote blower 33, so that the workers can take actions according to the degree of risk in the work environment.

In addition, in one safety cabinet 10 of the building, when the safety cabinet control unit 52 detects that the first determination condition is satisfied, the safety cabinet control unit 52 determines that a slight abnormality occurs in the operating state of the remote blower 33, and transmits the attention signal to the notification system. Upon receiving the attention signal, the notification system notifies the worker 50 of the safety cabinet 10.

On the other hand, in one safety cabinet 10 of the building, when the safety cabinet control unit 52 detects that the second determination condition is satisfied, the safety cabinet control unit 52 determines that a serious abnormality occurs in the operating state of the remote blower 33, and transmits the alarm signal to the notification system. Upon receiving the alarm signal, the notification system notifies workers throughout the building.

Accordingly, the workers in the building can take actions according to the degree of risk in the work environment.

Incidentally, when the notification system receives the attention signals from a predetermined percentage of the safety cabinets in the building, the notification system may notify the workers throughout the building.

In addition, a very small change or an abnormality in the operating state of the system is detected by monitoring fluctuations in power supply, an instantaneous power outage, and the state of the uninterruptible power supply (UPS), and the worker can be notified of the abnormality by transmitting a signal to the arithmetic processing device 51.

### Fourth Embodiment

In the present embodiment, an example of a safety cabinet including two exhaust ducts will be described.

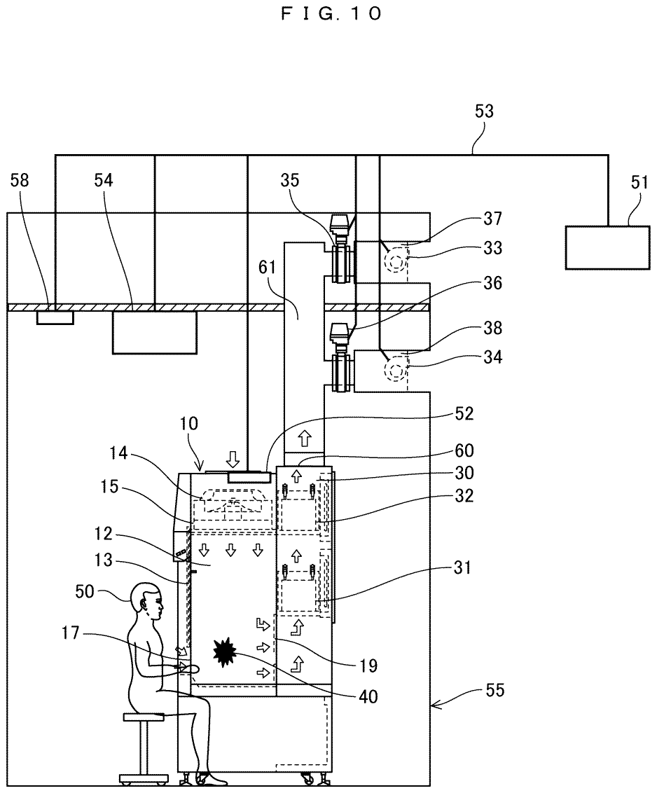

FIG. 10 is a right side view showing one example of a configuration of a safety cabinet of a fourth embodiment.

In FIG. 10, the same configurations in FIG. 4 are denoted by the same reference signs, and the descriptions thereof will be omitted. The safety cabinet 10 of FIG. 10 differs from that of FIG. 4 in that two exhaust ducts, namely, the exhaust duct 37 and a backup exhaust duct 38 provided in the building are provided.

As shown in FIG. 10, at an upper portion of the safety cabinet 10, the exhaust duct 37 connected to the vertical flow path 61 via the electric valve 35 and the backup exhaust duct 38 branching between the opening portion 60 of the vertical flow path 61 and the electric valve 35 and connected to the vertical flow path 61 via a backup electric valve 36 are provided. The backup electric valve 36 adjusts the air volume passing through the backup exhaust duct 38. The backup exhaust duct 38 includes a backup remote blower 34 that sends the air from the backup exhaust duct 38 to the outdoors.

Normally, since the electric valve 35 is opened and the remote blower 33 is operated, and the backup electric valve 36 is closed and the backup remote blower 34 is stopped, the air in the work space 12 of the safety cabinet 10 is exhausted to the outdoors through the exhaust duct 37.

When the remote blower 33 has abnormally stopped, the backup electric valve 36 is opened, the operation of the backup remote blower 34 is started, and the electric valve 35 is closed, so that the air in the work space 12 is exhausted to the outdoors through the backup exhaust duct 38.

When the safety cabinet control unit 52 has received an abnormal stop signal for the remote blower 33, the above-described exhaust operation can be realized by transmitting a startup signal for the backup remote blower 34, an open signal for the backup electric valve 36, and a close signal for the electric valve 35.

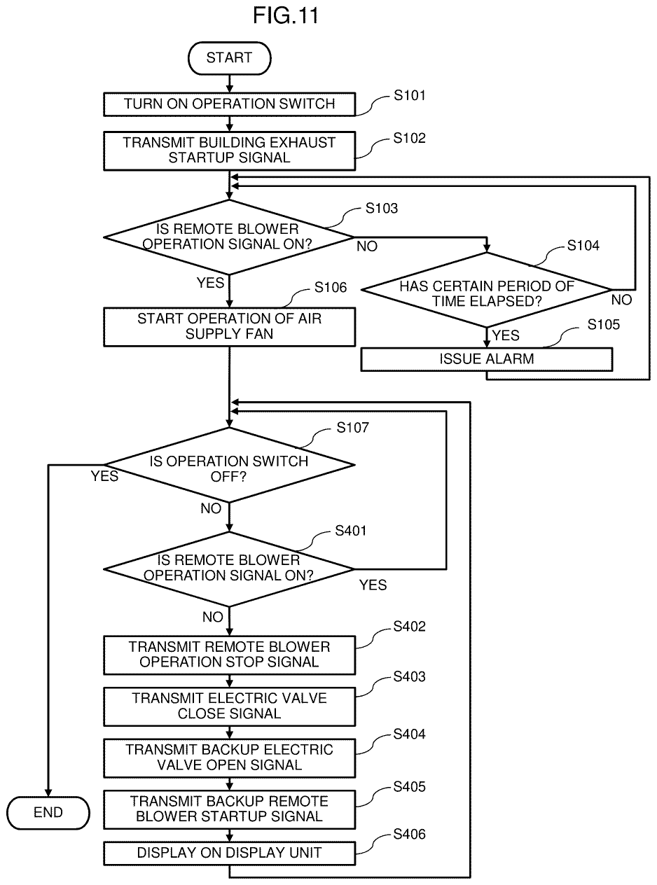

FIG. 11 is a flowchart showing one example of the operation of the safety cabinet of the fourth embodiment.

In FIG. 11, the same configurations in FIG. 5 are denoted by the same reference signs, and the descriptions thereof will be omitted.

Next, the safety cabinet control unit 52 determines whether or not the remote blower operation signal is ON (step S401), to monitor an abnormal stop of the remote blower 33. When the remote blower 33 has abnormally stopped, the exhaust to the outdoors cannot be performed; however, when the operation of the air supply fan 14 of the safety cabinet 10 is continued, clean air that has passed through the HEPA filter 15 for air supply passes through the work space 12, contains the contaminant 40, and blows out from the work opening portion 17 toward the worker 50, so that there is a possibility that the worker 50 is exposed to the contaminant 40, which is a risk.

In addition, in a case where the remote blower 33 has abnormally stopped, when the operation of the air supply fan 14 of the safety cabinet 10 is stopped, the contaminant 40 in the work space 12 floats in the work space 12, so that there is a possibility that the contaminant 40 leaks from the work opening portion 17 to the laboratory 55 in which the worker 50 is located.

In order to prevent the worker 50 from being exposed to the contaminant 40, when the remote blower 33 stops abnormally and the remote blower operation signal is OFF (NO in step S401), the safety cabinet control unit 52 transmits an operation stop signal to the remote blower 33 (step S402).

Next, the safety cabinet control unit 52 transmits the close signal to the electric valve 35 to fully close the exhaust flow path of the exhaust duct 37 (step S403), and transmits the open signal to the backup electric valve 36 to open the exhaust flow path of the backup exhaust duct 38 (step S404).

Further, the safety cabinet control unit 52 transmits the startup signal to the backup remote blower 34 to start the operation of the backup remote blower 34 (step S405), and switches the exhaust flow path from the exhaust duct 37 to the backup exhaust duct 38.

Accordingly, the contaminant 40 in the work space 12 passes through the first HEPA filter 31 for exhaust and the second HEPA filter 32 for exhaust, passes through the backup exhaust duct 38, and is exhausted to the outdoors, so that the contaminant 40 does not float in the work space 12. Therefore, there is no possibility that the contaminant 40 leaks from the work opening portion 17 to the laboratory 55 in which the worker 50 is located.

Next, in order to notify the worker 50 in the laboratory 55 that the remote blower 33 has abnormally stopped and the backup exhaust duct 38 is in use, the safety cabinet control unit 52 controls the display unit 54 to perform display (step S406), and returns to step S107. Incidentally, the buzzer 58 provided in the laboratory 55 may be sounded to notify the worker 50 that the remote blower 33 has abnormally stopped.

According to the present embodiment, even when the remote blower 33 has abnormally stopped, the required exhaust air volume of the safety cabinet 10 can be maintained, and the worker can be prevented from being exposed to the contaminant.

In addition, when the remote blower 33 has abnormally stopped, the electric valve 35 is closed and the remote blower 33 is isolated from the exhaust flow path of the safety cabinet 10, so that the remote blower 33 can be diagnosed for a failure or maintenance work can be performed even in a state where the safety cabinet 10 is in operation and use.

Further, the backup exhaust duct 38 is branched and provided between the opening portion 60 of the vertical flow path 61 and the electric valve 35 such that a distance of the exhaust flow path from the opening portion 60 to the backup electric valve 36 is shorter than a distance of the exhaust flow path from the opening portion 60 to the electric valve 35. For that reason, when the remote blower 33 has abnormally stopped, the switching of the exhaust flow path from the exhaust duct 37 to the backup exhaust duct 38 due to the abnormal stop of the remote blower 33 can be performed in a short time, and the leakage of contaminants can be prevented by preventing the disturbance of the air barrier of the work opening portion 17 of the safety cabinet 10.

### Fifth Embodiment

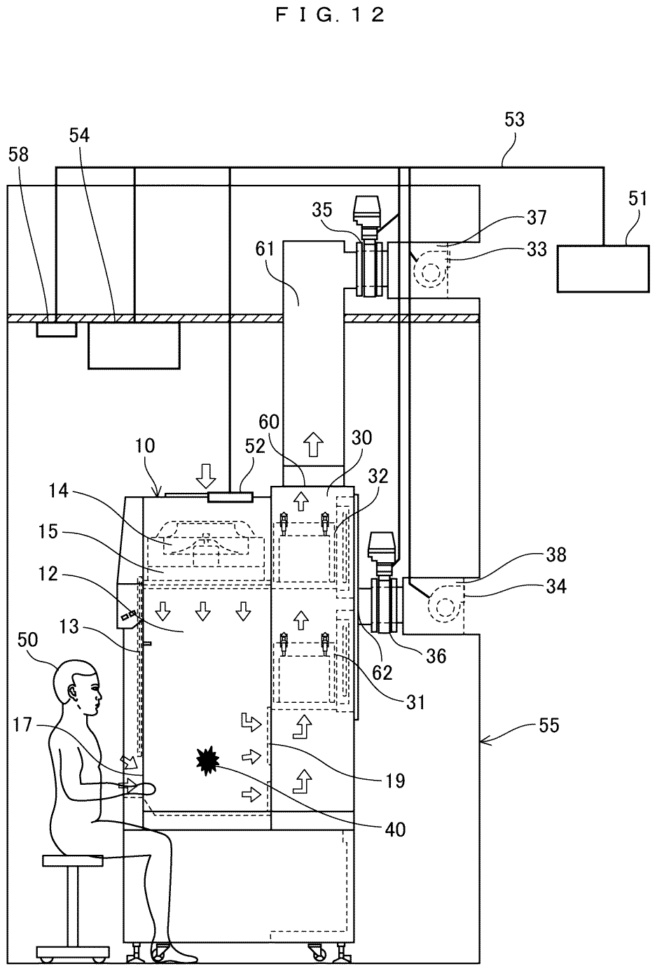

FIG. 12 is a right side view showing one example of a configuration of a safety cabinet of a fifth embodiment.

The fifth embodiment differs from the fourth embodiment of FIG. 10 in that the backup exhaust duct 38, the backup remote blower 34, and the backup electric valve 36 are disposed between the first HEPA filter 31 for exhaust and the second HEPA filter 32 for exhaust.

As shown in FIG. 12, the safety cabinet 10 includes an opening portion 62 for exhausting air to the outside of the safety cabinet 10 between the first HEPA filter 31 for exhaust and the second HEPA filter 32 for exhaust in the back flow path 30. The opening portion 62 is connected to the backup exhaust duct 38 via the backup electric valve 36.

Similarly to the fourth embodiment, when the remote blower 33 stops abnormally and the remote blower operation signal is OFF, the safety cabinet control unit 52 included in each of a plurality of the safety cabinets 10 transmits the close signal to the electric valve 35 to fully close the exhaust flow path of the exhaust duct 37, and transmits the open signal to the backup electric valve 36 to open the exhaust flow path of the backup exhaust duct 38. The safety cabinet control unit 52 transmits the startup signal to the backup remote blower 34 to start the operation of the backup remote blower 34, and switches the exhaust flow path from the exhaust duct 37 to the corresponding backup exhaust duct 38.

Incidentally, at least one of the respective safety cabinet control units 52 included in the plurality of safety cabinets 10 may transmit each signal.

According to the present embodiment, when the remote blower 33 has abnormally stopped, the exhaust flow path is switched from the exhaust duct 37 to the corresponding backup exhaust duct 38, so that the required exhaust amount of the safety cabinet 10 can be maintained, and workers can be prevented from being exposed to contaminants.

In addition, the opening portion 62 is provided between the first HEPA filter 31 for exhaust and the second HEPA filter 32 for exhaust in the back flow path 30 such that a distance of the exhaust flow path from the pre-filter 19 to the backup electric valve 36 is shorter than a distance of the exhaust flow path from the pre-filter 19 to the electric valve 35, and the backup exhaust duct 38 is connected to the opening portion 62. For that reason, when the remote blower 33 has abnormally stopped, the switching of the exhaust flow path from the exhaust duct 37 to the backup exhaust duct 38 can be performed in a short time, and the leakage of contaminants can be prevented by preventing the disturbance of the air barrier of the work opening portion 17 of the safety cabinet 10.

Further, according to the present embodiment, the opening portion 62 is provided between the first HEPA filter 31 for exhaust and the second HEPA filter 32 for exhaust in the back flow path 30 such that the exhaust from the backup exhaust duct 38 does not pass through the second HEPA filter 32 for exhaust, and the backup exhaust duct 38 is connected to the opening portion 62. For that reason, the exhaust resistance is reduced compared to when the exhaust passes through two HEPA filters for exhaust, so that the rated output of the backup remote blower 34 can be suppressed, and power consumption can be suppressed.

Incidentally, the opening portion 62 is disposed between the first HEPA filter 31 for exhaust and the second HEPA filter 32 for exhaust in the back flow path 30; however, the number of the HEPA filters for exhaust or the position where the opening portion 62 is disposed is not limited thereto. The opening portion 62 may be disposed to exhaust the air that has passed through at least one HEPA filter for exhaust.

### Sixth Embodiment

In the present embodiment, an example in which exhaust flow paths of a plurality of safety cabinets are collectively connected to one exhaust duct will be described.

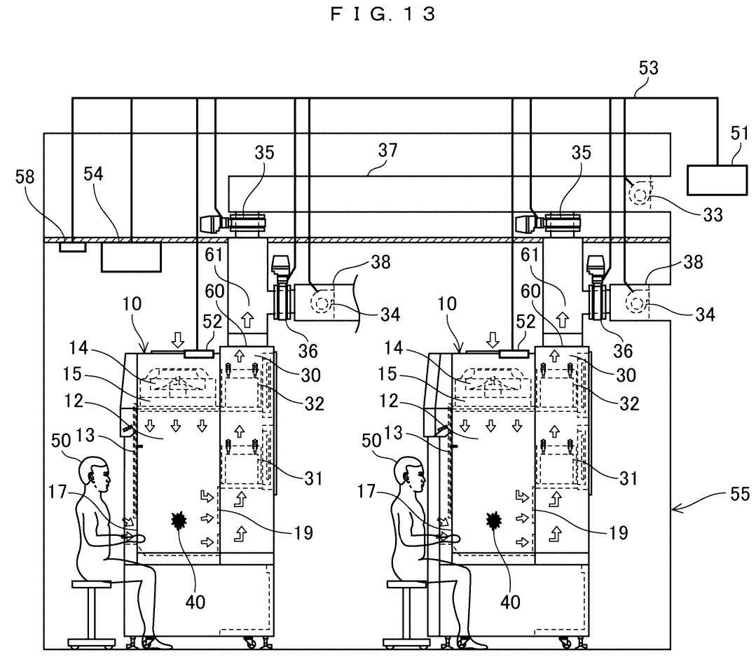

FIG. 13 is a right side view showing one example of a configuration of a safety cabinet of a sixth embodiment.

As shown in FIG. 13, a plurality of the safety cabinets 10 are configured such that the respective opening portions 60 are connected to the vertical flow paths 61 and the respective vertical flow paths 61 are connected to one exhaust duct 37 via the electric valves 35.

In addition, each of the plurality of safety cabinets 10 includes the backup exhaust duct 38 branching between the opening portion 60 of the vertical flow path 61 and the electric valve 35 and connected to the vertical flow path 61 via the backup electric valve 36. The backup electric valve 36 adjusts the air volume passing through the backup exhaust duct 38. The backup exhaust duct 38 includes the backup remote blower 34 that sends the air from the backup exhaust duct 38 to the outdoors.

When the remote blower 33 stops abnormally and the remote blower operation signal is OFF, the safety cabinet control unit 52 included in each of the plurality of safety cabinets 10 transmits the close signal to the electric valve 35 to fully close the exhaust flow path of the exhaust duct 37, and transmits the open signal to the backup electric valve 36 to open the exhaust flow path of the backup exhaust duct 38. The safety cabinet control unit 52 transmits the startup signal to the backup remote blower 34 to start the operation of the backup remote blower 34, and switches the exhaust flow path from the exhaust duct 37 to the corresponding backup exhaust duct 38.

When the plurality of safety cabinets are connected to one exhaust duct, the operation stop of one safety cabinet 10 causes the exhaust air volume of the other safety cabinets 10 to fluctuate, and causes a disturbance in the air barriers of the work opening portions 17, so that it is necessary to collectively stop the operation of the plurality of safety cabinets 10. When one safety cabinet has abnormally stopped, the disturbance of the air barriers of the work opening portions 17 can be prevented by switching the exhaust flow paths from the exhaust ducts 37 to the backup exhaust ducts 38.

According to the sixth embodiment, even when the remote blower 33 has abnormally stopped, the required exhaust amount of the safety cabinets 10 can be maintained, and workers can be prevented from being exposed to contaminants. In addition, since the plurality of safety cabinets 10 share one exhaust duct 37, the system can be manufactured at a low cost.

In FIG. 13, the configuration is such that the backup exhaust ducts 38 are disposed directly above the respective safety cabinets 10 and each of the backup exhaust ducts 38 includes the backup electric valve 36 and the backup remote blower 34; however, the configuration can be such that a plurality of the backup exhaust ducts 38 are connected and combined into one system.

In this case, since the backup exhaust ducts can be integrated into one, the system can be manufactured at a lower cost.

In each embodiment, the total exhaust type safety cabinet in which air taken in from the outside passes through the work space, contaminants are removed from the air by the HEPA filters, and all the air is exhausted to outside has been described; however, the present invention can also be used for a recirculation type safety cabinet that recirculates air to be exhausted by returning some of the air to the work space.

Incidentally, the present invention is not limited to the above-described embodiments, and includes various modification examples. For example, the above-described embodiments have been described in detail to facilitate understanding of the present invention, and are not necessarily limited to including all the described configurations. In addition, a part of the configuration of one embodiment can be replaced with the configuration of another embodiment, and the configuration of another embodiment can also be added to the configuration of one embodiment. In addition, other configurations can be added to, removed from, or replaced with a part of the configuration of each embodiment.

### REFERENCE SIGNS LIST

10 Safety cabinet
33 Remote blower
34 Backup remote blower
35 Electric valve
37 Exhaust duct
51 Arithmetic processing device
52 Safety cabinet control unit
54 Display unit
58 Buzzer

1. A safety cabinet comprising:
an opening portion for exhausting air in a work space;
an exhaust duct connected to the opening portion;
a remote blower that sends the air in the work space to outdoors from the exhaust duct; and
a control unit that transmits a signal to a notification system that notifies a worker based on values indicating the operating state of the remote blower.

2. The safety cabinet according to claim 1,
wherein the control unit
transmits an attention signal to the notification system when the values indicating the operating state satisfy a first predetermined determination condition, and
transmits an alarm signal to the notification system when the values indicating the operating state satisfy a second predetermined determination condition.

3. The safety cabinet according to claim 2,
wherein the notification system
notifies a worker of the safety cabinet when receiving the attention signal,
and notifies a worker in the building where the safety cabinet is installed when receiving the alarm signal.

4. The safety cabinet according to claim 2,
wherein the value indicating the operating state includes a plurality of items.

5. The safety cabinet according to claim 4,
wherein the value indicating the operating state includes the state of a power supply provided to the safety cabinet.

6. The safety cabinet according to claim 4,
wherein the control unit transmits the alarm signal to the notification system when the values indicating the operating state satisfy the first determination condition for a predetermined number or more of the plurality of items.

7. The safety cabinet according to claim 2,
wherein the control unit transmits the alarm signal to the notification system when the values indicating the operating state satisfy the first determination condition continuously for a predetermined period of time.

8. An equipment monitoring system for a safety cabinet comprising:
an opening portion for exhausting air in a work space;
an exhaust duct connected to the opening portion;
a remote blower that sends the air in the work space to outdoors from the exhaust duct;
a control unit that transmits a signal based on values indicating the operating state of the remote blower; and
a arithmetic processing device that notifies a worker based on the signal transmitted from the control unit.

9. The equipment monitoring system according to claim 8, further comprising:
at least one display unit;
wherein the arithmetic processing device controls the display unit to display based on the signal transmitted from the control unit.

10. The equipment monitoring system according to claim 7, further comprising:
at least one buzzer;
wherein the arithmetic processing device controls the buzzer to sound based on the signal transmitted from the control unit.

11. The equipment monitoring system according to claim 7,
wherein the arithmetic processing device broadcasts based on the signal transmitted from the control unit.
